(19) United States
(12) Patent Application Publication
(10) Pub. No.: US 2007/0248240 A1
(43) Pub. Date: Oct. 25, 2007

(54) Selective Video Blanking

(75) Inventor: Michael A. Epstein, Spring Valley, NY (US)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/568,487

(22) PCT Filed: May 2, 2005
(86) PCT No.: PCT/IB05/51424

§ 371 Date: Oct. 30, 2006

Related U.S. Application Data
(60) Provisional application No. 60/568,168, filed on May 5, 2004.

(51) Int. Cl. H04N 7/167

(52) U.S. Cl. 382/100

(57) ABSTRACT

Subsets of a video image (101) are analyzed to determine whether unauthorized playback-protected image is contained within the subsets. Regions of subsequent video images are prevented (210) from being displayed based upon whether the unauthorized playback-protected image is contained within the subsets. When a watermark is detected (220) within a video image, select areas (240) of the video image are included or excluded from subsequent watermark detection operations. When the inclusion/exclusion of an area results affects the ability to detect the watermark (260), a region that includes/excludes the area is identified (270) as a region that should not be displayed (210). The detection of other areas that affect the watermark detection results causes a redefinition (270) of the region to include/exclude the other areas.

This invention relates to the field of video processing, and in particular to the control of a display device to prevent unauthorized viewing of protected content material.

A variety of techniques have been developed to prevent the unauthorized rendering of playback-protected content material. When a conforming playback device detects information that identifies the material as being playback-protected, and does not detect suitable authorization information for this material, the device terminates the rendering of the protected content material.

Some of the techniques used to identify the material as being playback-protected provide identifying information in the format used to encode the video information, such as alteration of MPEG-encoded bit streams. Other techniques provide identifying information in the ancillary information provided with the material, such as in the “header” information on a DVD recording. Each of these techniques, however, eventually provides conventional video information to a display device, and an interception of this “unmarked” video information can be used to create unauthorized copies of the content material.

The more robust techniques for identifying protected video content material embed the protection information directly into the video images. Conventionally, this embedded information is termed a watermark, because, like the conventional paper watermark, the electronic watermark is designed to not interfere with the image quality, and yet to be virtually irremovable without causing substantial damage to the image. To minimize the impact on image quality caused by the introduction of additional information into the image, most watermarking systems embed the watermark information into “visually-busy” regions of the image, because the human eye is less sensitive to distortions in complex visual patterns than distortions in homogeneous or “visually-flat” regions. Additionally, some watermarking systems embed the watermark information into key figures or objects in a scene, so that the attempted removal of the watermark information is more likely to produce undesirable images, due to the corresponding “directed” damage to these key figures or objects.

By embedding the playback-protecting identification in the video image, playback protection can be provided by the display device, thereby preventing unauthorized display of the material regardless of how the material arrived at the display device. A conforming display device continually monitors the image information, and if protection information is detected without corresponding authorization information, the display device terminates the display of the image. The display device may be configured to continue to process the input video stream while not displaying the video image, to determine when the protected material is replaced by unprotected or authorized material; or, it may be required to be reset, via for example, a power-on/power-off sequence, after each attempted viewing of unauthorized material.

A problem associated with this display-termination, or video-blanking, arises if the display device receives a video stream corresponding to multiple independent image streams. For example, a computer system may allow for multiple windows to be displayed on a display screen, each window corresponding to a different set of content material. The computer device creates a composite video image that contains the visible portions of each window, and sends this composite image to a display device. The display device is unaware of whether the received image comprises one full screen window, or dozens of independent windows. Thus, if a conforming display device detects playback-protecting information in any portion of the received image without corresponding authorization, the conforming display device will terminate the display of the entire video stream from the computer system. In like manner, a conforming display device in a home entertainment system may receive a single video stream from a video multiplexer with a variety of source feeds, and the occurrence of unauthorized playback-protection information from any of the sources will cause a termination of the display of all the information from the video multiplexer. For example, if the video multiplexer provides picture-in-picture capabilities, attempting to display protected material in the PIP window will cause a termination of the display of the entire image.

Although the termination of the display of the entire video stream may be deemed by some to be a suitable penalty for attempting to display unauthorized material, this total video-blanking can cause unintended side-effects. For example, the user may not purposely be attempting to display unauthorized material, and may not be aware of the immediate source of the problem when the display device terminates the display. Further, it will be difficult to identify the source of the problem with an inoperative display device. Consumer acceptance of a protection scheme that is over-extensive and difficult to correct is not expected to be high.

Additionally, this over-extensive display termination may be used by some users as a means of inflicting damage on others. For example, a nefarious person could purposely send a playback-protected image via email to unsuspecting recipients. When a recipient attempts to view the image from a computer system via a conforming display device, the display device will detect the unauthorized playback-protected image and terminate the display of the entire video stream from the computer. Without a display, it will be difficult for the recipient to correct the problem without doing a “hard” shutdown of the computer system, which could cause the recipient to lose any unsaved work from other windows.

It is an object of this invention to avoid the termination of display from a video source when an unauthorized playback-protection image is detected. It is a further object of this invention to terminate the display of selected portions of a video image from a video source when an unauthorized playback-protected image is detected.

These objects, and others, are achieved by selectively analyzing subsets of a video image for the presence of unauthorized playback-protected image within the subsets. Regions of subsequent video images are prevented from being displayed based upon whether the unauthorized playback-protected image is contained within the subsets. In a first embodiment, when a watermark is detected within a video image, select areas of the video image are excluded from subsequent watermark detection operations. When the exclusion of an area results in an inability to detect the watermark, a region that includes the area is identified as a region that should not be displayed. In an alternative embodiment, selected areas of the video image are included in subsequent watermark detection operations, and when the inclusion of an area results in an ability to detect the watermark, the area is identified as a region that should not be displayed. The detection of other areas that affect the watermark detection results causes a redefinition of the display-excluded region to include or exclude the other areas.

The invention is explained in further detail, and by way of example, with reference to the accompanying drawings wherein:

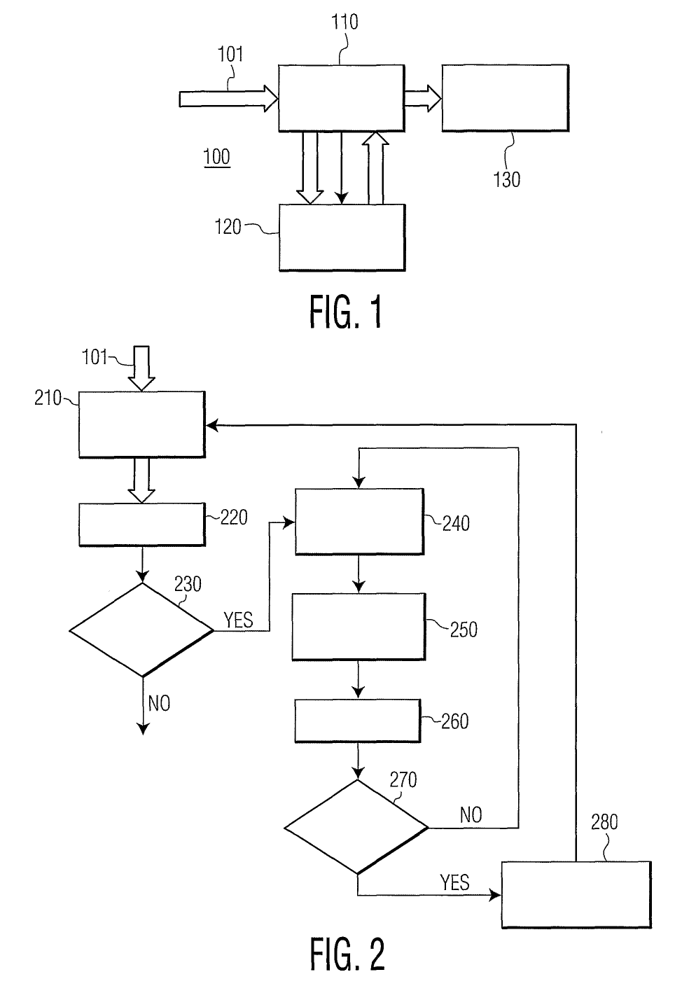

FIG. 1 illustrates an example block diagram of a display device in accordance with this invention.

FIG. 2 illustrates an example flow diagram for control of a display device in accordance with this invention.

Throughout the drawings, the same reference numeral refers to the same element, or an element that performs substantially the same function. The drawings are included for illustrative purposes and are not intended to limit the scope of the invention.

The invention is presented in the context of a protection system that uses watermarks to identify protected material. One of ordinary skill in the art will recognize that other identifying techniques, such as fingerprinting and explicit marking may also be used. For ease of reference and understanding, the term “watermark” is used hereinafter to identify any object or artifact that is attached to protected material to identify the material as such.

FIG. 1 illustrates an example block diagram of a display device 100 in accordance with this invention. The display device 100 includes a video processor 110, a video filter 120, and a display screen 130, and is configured to provide a display of received content material 101. One of ordinary skill in the art will recognize that these blocks may be embodied in various alternative forms, including alternative combinations of hardware and software elements, alternative degrees of integration, and alternative structures.

The video processor 110 is configured to control the display of received content material 101 via the display screen 130. In a conventional display device, such a video processor might be configured to prevent the display of the received content material 101 whenever a protective marking is detected in the image from the received content material, and the protective marking is not associated with a corresponding authorization at the display device, but as noted above, such a total-display-prevention whenever a protective marking that is not associated with a corresponding authorization is detected is not a practical solution. For the purposes of this disclosure and for ease of reference, a “protective marking that is not associated with a corresponding authorization” is hereinafter defined herein as an “unauthorized watermark”, which signifies a marking that does not have a corresponding authorization, thereby indicating that the associated content material is unauthorized.

In accordance with this invention, the video filter 120 is configured to provide filtered images comprising subsets of the received image to the video processor 100, and the video processor is configured to determine whether an unauthorized watermark is found in the filtered image. The operation of the display device 100 is best understood with reference to the flowchart of FIG. 2.

FIG. 2 illustrates an example flow diagram for control of a display device, such as illustrated in FIG. 1, in accordance with this invention. A received image is processed at 210 to apply selective “blanking”, discussed further below. Initially, no blanking is applied, and the entire received image is provided to block 220 to determine whether a watermark is present in the image. If, at 230, an unauthorized watermark is detected in the image, the process enters the loop 240-270 to isolate the area of the image that contains the watermark, or, conversely, to isolate the area of the image that does not contain the watermark.

As discussed above, a typical display device may be used to display an image that is formed as a composite of images from multiple sources, such as a computer display containing multiple windows, a television display with picture-in-picture, a multimedia display with a video mixer, and so on. Although the image contains an unauthorized watermark, it may be inappropriate to terminate the display of the entire image, and the filtering process is intended to distinguish the portions of the image that contain the watermark from the portions of the image that do not contain the watermark.

At 240, an area of the image is selected. In an example embodiment, the selection process includes dividing the image into a matrix of blocks and selecting one or more blocks as the selected area upon which to base the filtering. Any number of techniques can be employed to search the image for the watermark, including a sequential block-by-block search, a progressive binary search, a random search, and so on. In an example embodiment, the image is partitioned into an 8×8 or 16×16 matrix of areas, and a sequential block-by-block assessment is performed.

At 250, the image is filtered based on the selected area. This filtering may be inclusive or exclusive. If inclusive filtering is used, the selected area of the image is provided to the watermark detector 260; if exclusive filtering is used, all the other area of the image, except the selected area, is provided to the watermark detector 260.

The decision block 270 of FIG. 2 illustrates the flow in an exclusive filtering process, wherein, if, at 270, the detected watermark from the detector 260 does not differ from the originally detected watermark at 220, this implies that the selected area does not contain the watermark, and a new area is selected, at 240, and the process is repeated. If, at 270, the watermark of the filtered image from the detector 260 differs from the watermark detected at 220, this implies that the selected area contains at least a portion of the watermark, and the search-loop 240-270 is terminated, and the process continues at block 280.

If inclusive filtering is used, the decision block at 270 is configured to loop back to block 240 if a watermark is not found in the selected area, and to proceed to block 280 if a watermark is found in the selected area.

At 280, the selected area is used to define and/or redefine a “blocking region” that is used to selectively block one or more portions of the image from being displayed. The prevention of display of a portion of an image is hereinafter referred to as “blanking” the portion of the image, because typically the blocked region will appear as an area that is devoid of image information.

At 210, the blanking is applied to each subsequent received image. This blanking is preferably applied to each subsequent received image before the image is provided to the watermark detector 220, to avoid repeated identification of the same area containing at least a portion of the watermark.

As each subsequent selectively blanked image is provided to the watermark detector 220, any other unauthorized watermarks or substantial remnants of watermarks will be detected, and the search process 240-270 will be repeated. This repeated processing allows for the selective blocking of regions corresponding to multiple sources of unauthorized material, and/or for the selective blocking of increasingly larger areas of an image from a single unauthorized source. That is, for example, as noted above, some watermarking techniques apply the watermark in portions of the image that are visually “busy”, to reduce the perception of the distortions produced by the watermark. Thus, only a relatively small area of a protected image will contain a watermark. The particular location of the watermarked area within the image, however, is likely to change as the image scenes change. By identifying areas in subsequent images that contain an unauthorized watermark, eventually the entire display area occupied by the unauthorized image, or at least a substantial portion of the entire display area, will likely be blanked out. Additionally, the detection of unauthorized watermarks in subsequent selectively blanked images will progressively blank out more and more of the user's display if the user attempts to avoid this protection scheme by moving the image of the protected material to another location on the display screen.

One of ordinary skill in the art will recognize, in view of this disclosure, that other techniques may be used for defining the blanking regions at block 280. For example, if first and second areas are found to contain a watermark, the blocking region can be defined as a bounding rectangle that encompasses the first and second areas. Subsequent detections of unauthorized watermarks will expand the size of the blanking rectangle.

As noted above, other techniques may be used to isolate the area or areas containing unauthorized watermarks. For example, an initial search could partition the image in half, to determine whether the unauthorized watermark is only located in half the image, then partition the half into quarters, and so on, until the smallest partitioned area containing the unauthorized watermark is located. Note that is this process, the blanking region is not defined until the smallest partitioned area is determined.

In like manner, the process used for selective blanking may be structured differently from the above presentation. For example, the watermark detection and iterative locating process requires some processing time, during which time the protected material may be displayed. In an alternative embodiment, upon originally detecting an unauthorized watermark, the entire image may be blanked, and then selective regions are “un-blanked” as they are determined to be clear of the unauthorized watermark. Preferably, this un-blanking would not un-blank any region that had been previously determined to contain an unauthorized watermark, thereby facilitating the aforementioned progressive blanking of image streams that vary the placement of the watermark.

The foregoing merely illustrates the principles of the invention. It will thus be appreciated that those skilled in the art will be able to devise various arrangements which, although not explicitly described or shown herein, embody the principles of the invention and are thus within the spirit and scope of the following claims.

In interpreting these claims, it should be understood that:

a) the word “comprising” does not exclude the presence of other elements or acts than those listed in a given claim;

b) the word “a” or “an” preceding an element does not exclude the presence of a plurality of such elements;

c) any reference signs in the claims do not limit their scope;

d) several “means” may be represented by the same item or hardware or software implemented structure or function;

e) each of the disclosed elements may be comprised of hardware portions (e.g., including discrete and integrated electronic circuitry), software portions (e.g., computer programming), and any combination thereof,

f) hardware portions may be comprised of one or both of analog and digital portions;

g) any of the disclosed devices or portions thereof may be combined together or separated into further portions unless specifically stated otherwise; and

h) no specific sequence of acts is intended to be required unless specifically indicated.

1. A display device (100) comprising:
an input port that receives a video image (101) from a source,
a display screen (130) that is configured to display the video image (101),
a video filter (120) that is configured to create a filtered image from the video image (101),
the filtered image corresponding to a subset of the video image (101), a video processor (110) that is configured to:
determine whether a watermark is present in the filtered image, and
prevent display of a portion of subsequent video images on the display screen (130) based on the filtered image and whether the watermark is present,
the portion of the subsequent video images that is prevented from display being less than an entirety of the video image (101).

2. The display device (100) of claim 1, wherein
the video filter (120) is configured to eliminate a select area of the video image (101) to form the filtered image.

3. The display device (100) of claim 2, wherein
the video processor (110) is configured to prevent display of the portion of the subsequent video images when the watermark is determined to be absent from the filtered image, and
the portion of the subsequent video images that the video processor (110) prevents from being displayed includes the select area.

4. The display device (100) of claim 3, wherein
the video filter (120) is configured to eliminate an other select area of an other video image to form an other filtered image, and
the video processor (110) is further configured to determine whether an other watermark is present in the other filtered image, and
the portion of the subsequent video images that the video processor (110) prevents from being displayed includes the select area and the other select area.

5. The display device (100) of claim 2, wherein
the video processor (110) is configured to prevent display of the portion of the subsequent video images when the watermark is determined to be present in the filtered image, and
the portion of the subsequent video images that the video processor (110) prevents from being displayed does not include the select area.

6. The display device (100) of claim 5, wherein
the video filter (120) is configured to eliminate an other select area of an other video image to form an other filtered image, and
the video processor (110) is further configured to determine whether an other watermark is present in the other filtered image, and
the portion of the subsequent video images that the video processor (110) prevents from being displayed does not include the select area and the other select area.

7. The display device (100) of claim 1, wherein
the video filter (120) is configured to include a select area of the video image (101) to form the filtered image.

8. The display device (100) of claim 7, wherein
the video processor (110) is configured to prevent display of the portion of the subsequent video images when the watermark is determined to be absent from the filtered image, and
the portion of the subsequent video images that the video processor (110) prevents from being displayed does not include the select area.

9. The display device (100) of claim 8, wherein
the video filter (120) is configured to eliminate an other select area of an other video image (101) to form an other filtered image, and
the video processor (110) is further configured to determine whether an other watermark is present in the other filtered image, and
the portion of the subsequent video images that the video processor (110) prevents from being displayed does not include the select area and the other select area.

10. The display device (100) of claim 8, wherein
the video processor (110) is configured to prevent display of the portion of the subsequent video images when the watermark is determined to be present in the filtered image, and
the portion of the subsequent video images that the video processor (110) prevents from being displayed includes the select area.

11. The display device (100) of claim 10, wherein
the video filter (120) is configured to eliminate an other select area of an other video image to form an other filtered image, and
the video processor (110) is further configured to determine whether an other watermark is present in the other filtered image, and
the portion of the subsequent video images that the video processor (110) prevents from being displayed includes the select area and the other select area.

12. A method of controlling display of regions of video images, comprising:
filtering (250) a video image (101) of the video images to form a filtered image,
the filtered image being a subset of the video image (101),
determining (260) whether the filtered image contains a watermark,
preventing (210) display of a region of the video images (280) based on the filtering (250), and based on whether the filtered image contains the watermark (260),
the region being less than an entirety of the video image (101).

13. The method of claim 12, wherein
preventing (210) the display of the region is based on (270) an absence of the watermark in the filtered image, and
the filtering (250) of the video image (101) includes an exclusion of an area within the region (280).

14. The method of claim 12, wherein
preventing (210) the display of the region is based on (270) a presence of the watermark in the filtered image, and
the filtering (250) of the video image (101) includes an inclusion of an area within the region (280).

15. The method of claim 12, further including
filtering (250) an other video image of the video images to form an other filtered image,
determining (260) whether the other filtered image contains an other watermark, and
wherein
the region of the video images that is prevented from display (280) is further based on whether the other filtered image contains the watermark (260).

16. The method of claim 15, wherein
preventing (210) the display of the region is based on (270) an absence of the watermark in the other filtered image, and
the filtering (250) of the other video image includes an exclusion of an other area within the region (280).

17. The method of claim 15, wherein
preventing (210) the display of the region is based on (270) a presence of the watermark in the other filtered image, and
the filtering (250) of the video image includes an inclusion of an other area within the region (280).
